(19) United States
(12) Patent Application Publication
(10) Pub. No.: US 2012/0310994 A1
(43) Pub. Date: Dec. 6, 2012

(54) Stability-Adjusted Ranking and Geographic Anchoring Using a Finite Set of Accessed Items

(75) Inventors: Thomas Katsuhiko Bando Wionzek, Seattle, WA (US); David John Rasmussen, Redmond, WA (US); David Christopher Tse, Kirkland, WA (US); Olga Veselova, Redmond, WA (US)

(73) Assignee: MICROSOFT CORPORATION, Redmond, WA (US)

(21) Appl. No.: 13/153,853

(22) Filed: Jun. 6, 2011

(51) Int. Cl. G06F 17/30

(52) U.S. Cl. 707/803; 707/E17.005

(57) ABSTRACT

List maintenance functionality is provided in part to maintain aspects of a list interface based in part on the use of a population algorithm configured in part to preserve relative ordering of list items, but the embodiments are not so limited. A computer-based method of an embodiment provides a list to an end-user that includes a finite number of list item locations based in part on a recent list population algorithm and a data structure to maintain list entries that are ultimately displayed to the end-user. In one embodiment, a note-taking application interface uses a population algorithm to maintain a list of accessed note items including the use of one or more note timestamps to populate a user's viewed item list.

### BACKGROUND

Computer applications can use a list of shortcuts for most frequently used (MFU) or most recently used (MRU) items. However, such usage lists do not always reflect items currently desired by an end-user. For example, a standard “Recent Items” view found in many software applications generally follows the MRU model. The MRU model can be used as part of ranking “Recent Items” adhering strictly to the temporal order in which each item was viewed last. The goal of a recently accessed view is generally to provide a shortcut to recently viewed items. However, the MRU model breaks down for scenarios in which an item is returned to repeatedly. As an example of its consequence, users who use the MRU model to repeatedly access the same items within a set often find themselves disoriented, without understanding the disorienting cause.

Based on testing of a typical MRU model, one disorientating cause lies in the inherent instability in the geographical positioning of the list items. For example, in one MRU model, the last item accessed can be found at the top of the MRU list. As a user navigates to a different location, the new location is placed at the top of the MRU list. Thus, when the user returns to the same list a moment later, at first glance the list can appear to be a completely different list. Despite knowing exactly why this should be the case, it often requires users a moment or two before regaining a sense of orientation in the list. Frequent testing of prior list provision solutions suggests that the lack of navigation certainty can garner negative sentiment after repeated list usage.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments provide functionality to maintain aspects of a list interface based in part on the use of a population algorithm configured in part to preserve relative ordering of list items, but the embodiments are not so limited. In an embodiment, a computer-based method can be configured to provide a list to an end-user that includes a finite number of list item locations based in part on a recent list population algorithm and a data structure including temporal information to maintain list entries that are ultimately displayed to the end-user. In one embodiment, a note-taking application interface uses a population algorithm to maintain a list of accessed note items including the use or one or more note timestamps to populate a user's viewed item list. Other embodiments are included.

These and other features and advantages will be apparent from a reading of the following detailed description and a review of the associated drawings. It is to be understood that both the foregoing general description and the following detailed description are explanatory only and are not restrictive of the invention as claimed.

### BRIEF DESCRIPTION OF THE DRAWINGS

FIG. 1 is a block diagram of an exemplary system.

FIG. 2 is a flow diagram depicting an exemplary process that includes the use of a population algorithm to maintain aspects of an accessed items list.

FIGS. 3A-3G depict list population examples for a recent items list using a population algorithm as part of preserving relative ordering of list items.

FIG. 4 depicts a smartphone that includes a recent note item list interface.

FIG. 5 is a flow diagram depicting an exemplary process that includes the use of a recent list population algorithm to maintain aspects of a recent list of viewed or visited note items.

FIGS. 6A-6G depict list population examples.

FIG. 7 is a block diagram illustrating an exemplary computing environment for implementation of various embodiments described herein.

### DETAILED DESCRIPTION

As described below, embodiments are provided that include functionality to maintain aspects of a list of user selections as part of providing a user interface to present selection information to an end-user, but are not so limited. In an embodiment, a computer-based method can be configured to provide a list that includes a finite number of user selection entries based in part on a population algorithm used to maintain a data structure corresponding to entries in the list used as an output and ultimately displayed to the end-user. For example, the population algorithm can be used to maintain a list of note-taking application items as part of providing the associated list maintenance functionality to a smart phone user using the note-taking application.

In an embodiment, components of computer-based system can provide information using a population or recent items algorithm configured in part to preserve geographical positioning and/or anchoring of list items, wherein repeat accesses to existing list items do not change item ordering in the list. The recent items algorithm uses a combination of new and previously accessed or visited/viewed items to gradually change a presentation of the list based in part on new popular items gradually rising to the topmost positions of the list, and items no longer useful generally disappearing over time.

The population algorithm of one embodiment provides for the frequency and stability adjusted ranking of finite sets of recently accessed items used in part to control the ordering of a “Recent Items” or “Recent Locations” list. Since the population algorithm of such an embodiment operates in part by not changing list order when existing entries are revisited, and removing least frequently used or least recently accessed entries as new entries are added, frequent use of a generated recent list preserves a feeling of familiar geographical anchoring for the list entries providing desirable and consistent interactive features as part of a repeated-use access or navigation system.

In an embodiment, a note-taking application for use with a processor-based system can be configured to include a high-level navigation pane that provides a short list of the most recent notes visited, including an optimized ordering of recent notes based in part on frequent and regular access and/or use. For example, the navigation pane can present a short list of the most recently visited notes including a description of the notebook locations for each entry in the recent notes list. In one embodiment, a list population algorithm is configured to populate a recent notes list by: 1) adding a link entry to a page to the bottom of the recent notes list whenever a page is viewed, edited, or created that is not already reflected in the recent notes list; 2) selectively removing an item associated with a least recently accessed page from the list as part of a full capacity list population operation if the list is full when a new entry is added; and 3) maintaining geographic position and the order of the existing items in the recent notes list if a page already reflected in the list is viewed, accessed, and/or edited again.

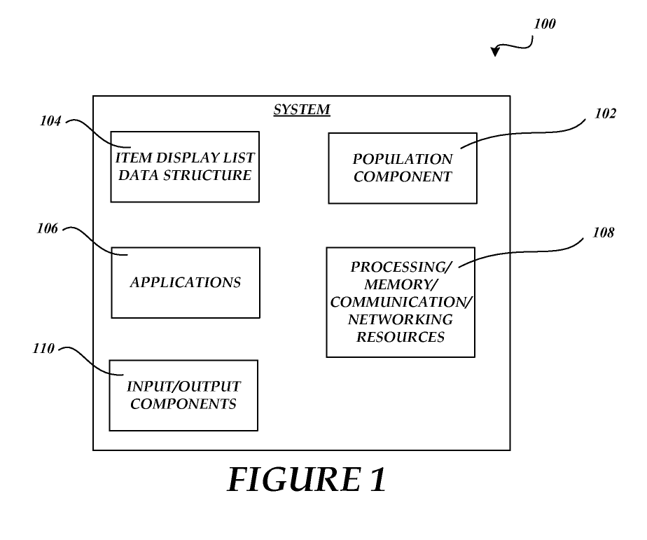

FIG. 1 is a block diagram depicting an exemplary system 100 that includes components configured in part to provide a presentation of information based in part on a population algorithm and information associated with a number of selected or visited items, but the components are not so limited. For example, functionality provided by the system 100 can be included as part of a desktop, laptop, handheld, tablet, or other type of computing or communication device/system. The system 100 of an embodiment includes computer processing, storage, and other components/resources that provide communication functionality and features, including recent list item maintenance features, as described in detail below.

As shown in FIG. 1, the exemplary system 100 includes a population component 102 that uses a population algorithm to populate aspects of a display list, such as part of providing a consistent and recognizable recent item list configuration for example. The system 100 also includes an item display list data structure 104 associated with the list, various user applications 106 such as a note-taking application and other user applications for example, processing, memory, communication and other resources 108, and input/output components 110 (e.g., microphone, mouse, pen/stylus, display, touchscreen, etc.).

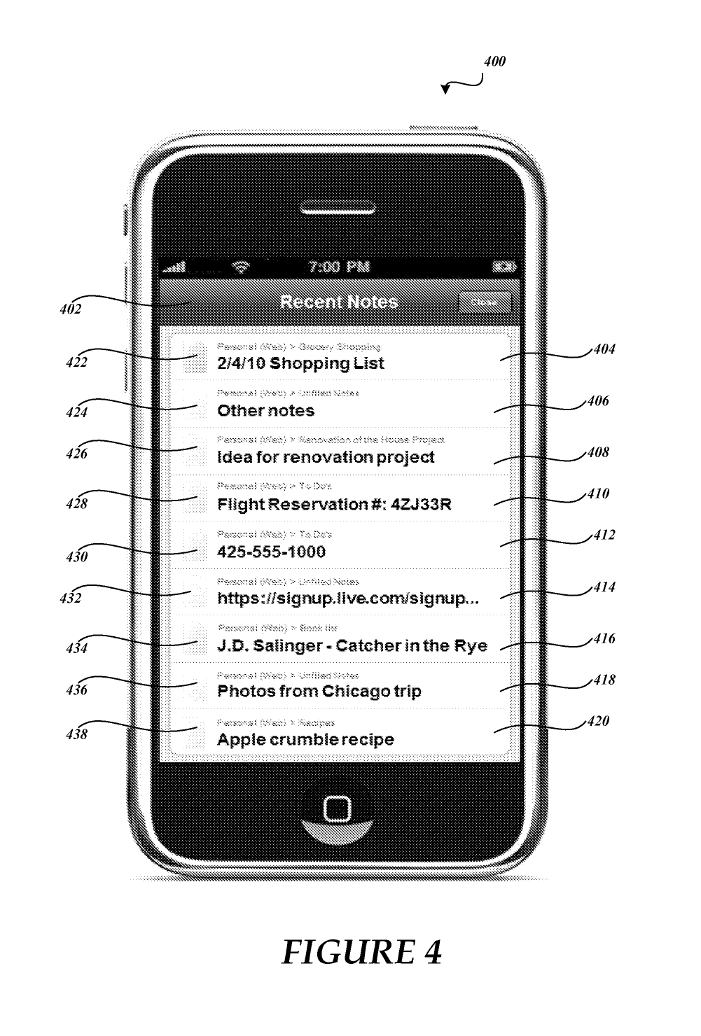

In various aspects, the item display list data structure 104 can be used to track local and/or remote user selections as part of populating a recent item list that displays information associated with user interactions and/or selection. The item display list data structure 104 can include additional information than provided in a particular recent items list. As an example, the population algorithm can use the item display list data structure 104 to provide a geographical anchoring mechanism as part of providing a familiar navigation paradigm of organized content for a note-taking or other application user or users, including single-user and multi-user applications (e.g., shared notebooks) (see FIG. 4).

As described further below, the population component 102 uses the population algorithm and the item display list data structure 104 to track local and/or remote user selections as part of populating a recent item list that displays information associated with various user interactions and/or selections. In an embodiment, the item display list data structure 104 is used by the population component 102 in part to track user selections or item viewing operations made during the course of interacting with an application, such as a note-taking application configured to operate in conjunction with a handheld device for example.

In one embodiment, the item display list data structure 104 includes temporal and/or other list maintenance information (e.g., one or more of timestamps, hashes, revision ID information, etc.) which is used by the population component 102 in determining whether to remove a particular list item when the list is full and a new item is to be populated or included in a recent item display list. List item tracking and/or display functionality can be used as part of locally installed application (e.g., a note-taking application) and/or remotely accessed application using a computer network, such as a global communication network used by smartphone and other handheld communication device users for example. For example, a user may use a note-taking application to access one or more note pages from a server using a handheld device.

In an embodiment, components of the exemplary system 100 can be configured to provide user selection navigation features and functionality within the framework of note-taking application for use with desktop, laptop, tablet, smartphone, and other computing devices that include the use of processor and memory resources to provide communication and interactive application functionality. In one embodiment, the population component 102 uses the population algorithm to maintain a recent item list that includes a finite number of displayable list item locations.

Upon a user accessing or viewing an item (via a control input, such as vocal, touch, mouse, etc.), the population component 102 uses the population algorithm to update the recent item list by: 1) determining if the accessed item is already included in the list and, if true, keep the item at the current list position and update the associated timestamp; and 2) if a new item is accessed or viewed that is not currently in the list (absent from the list) and the list is at a maximum size having all of the displayable list locations filled with list items, then remove the least frequently or least recent (e.g., based on oldest timestamp) accessed item in the list based on the value of the corresponding timestamp and add the new current item to a predetermined displayable item location or position of the recent item list (e.g., add the new current item to the bottommost, topmost, or other displayable list location).

The population algorithm of an embodiment is configured in part to preserve geographical and/or spatial positioning of revisited and/or reused list items to preserve list item awareness and positional recognition based in part on maintaining geographic relative positioning and/or ordering of each individual user's recent items list or menu (e.g., fixed list, drop down list, pop-up list, etc.). Correspondingly, the population algorithm can be used to provide a repeatable list of viewed items by maintaining and/or controlling an instantly recognizable personalized configuration of each user's recent items list such that repeat accesses to items already included in the recent items list do not change the list's ordering.

The population algorithm of an embodiment uses as inputs a combination of information associated with new and previously accessed item visitations, wherein the population algorithm uses the inputs to gradually make list changes as new popular items gradually rise to the top (or bottom in another implementation), and items less recently used (implying less frequent use in practice) or no longer useful disappear from the recent items list over time. The resulting geographical list item anchoring features provide for the comfortable repeated navigation of organized content associated with the recent items list. While a number of embodiments are described, it will be appreciated that other embodiments are included and implementable.

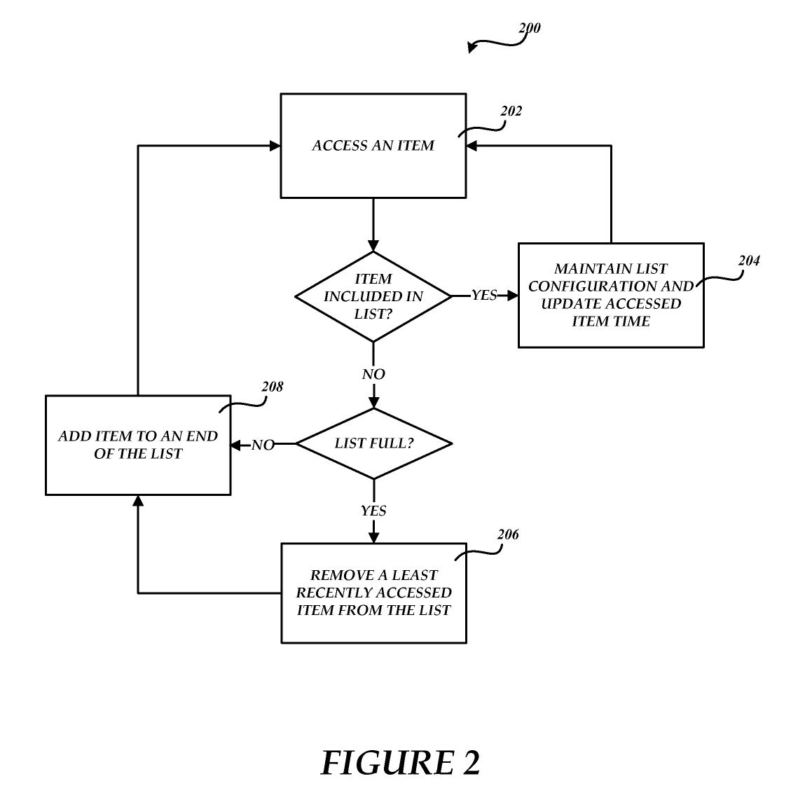

FIG. 2 is a flow diagram depicting an exemplary process 200 that includes the use of a list population algorithm to maintain aspects of an accessed items list as part of a user's interaction with a computer application, but is not so limited. For example, the exemplary process 200 can use the list population algorithm as part of controlling a presentation of recently used application items for an end-user, such as various selected or viewed note items provided as part of using a note-taking application interface. In one embodiment, the process 200 can be encoded with the population algorithm in part to provide list maintenance operations as part of providing note-taking application interface features.

The process 200 of an embodiment begins at 202 when a user navigates to, accesses, and/or views an item, such as a note-taking application item for example. For example, a user can use an input mechanism to provide a control input to a device or system that operates to select a desired application item from within the application, a directory location, or some other location or application, such as a note-taking application item as one example. At 204, if the process 200 determines that a currently accessed item is already included in the list, the process 200 does not change the list configuration or orientation for display as part of maintaining the geographic positioning of the existing list items, updates the access time associated with the currently accessed item, and returns to 202. For example, a data structure can be used in part to track and maintain temporal information, such as one or more timestamps for example, associated with each displayed list item of the accessed items list.

However, if the process 200 determines that the currently accessed item is not included in the list, and if the accessed items list is full, the process 200 proceeds to 206 and removes a least recently accessed entry from the accessed items list. The process 200 of one embodiment at 206 uses an accessed items list data structure to store and maintain timestamps of existing list items to determine the oldest or stalest item which corresponds to the least recently used list item. The process 200 of an embodiment proceeds to 208 and the currently accessed item is added to an end of the accessed items list including storing the associated timestamp in the accessed items list data structure for subsequent recent use determinations.

Based on the location of the removed item in the accessed items list, the process 200 can refresh the remaining existing items in the list to reflect the updated list configuration which includes the currently accessed item now positioned at the end of the accessed items list. For example, for removed items other than an item removed from the list end, the process 200 can operate to repopulate remaining locations by moving an adjacent item into the now removed item location and so on up or down the list. In one embodiment, the process 200 can be selectively configured by the user to repopulate or reorder the entire list or some portion based on timestamps of the list items. For example, the process 200 can be used as part of local and/or remote maintenance of last viewed application items that populate a list based on selection actions of a particular end-user. In an alternative embodiment, the process 200 can operate to insert the currently accessed item in place of a removed item in part to maintain the geographic relative positioning aspects of the presentation of visible list items.

On the other hand, if the accessed items list is not full, the process 200 proceeds to 208 and the currently accessed item is added to the end (e.g., top or bottom) of the accessed items list and the associated timestamp is stored in the accessed items list data structure for subsequent recent use determinations. While a certain number and order of operations is described for the exemplary flow of FIG. 2, it will be appreciated that other numbers and/or orders can be used according to desired implementations.

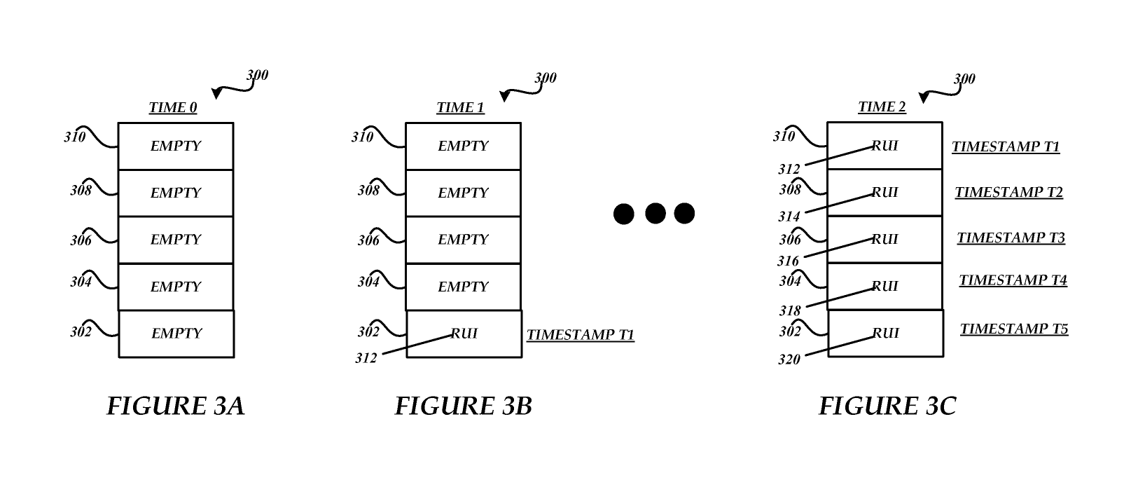

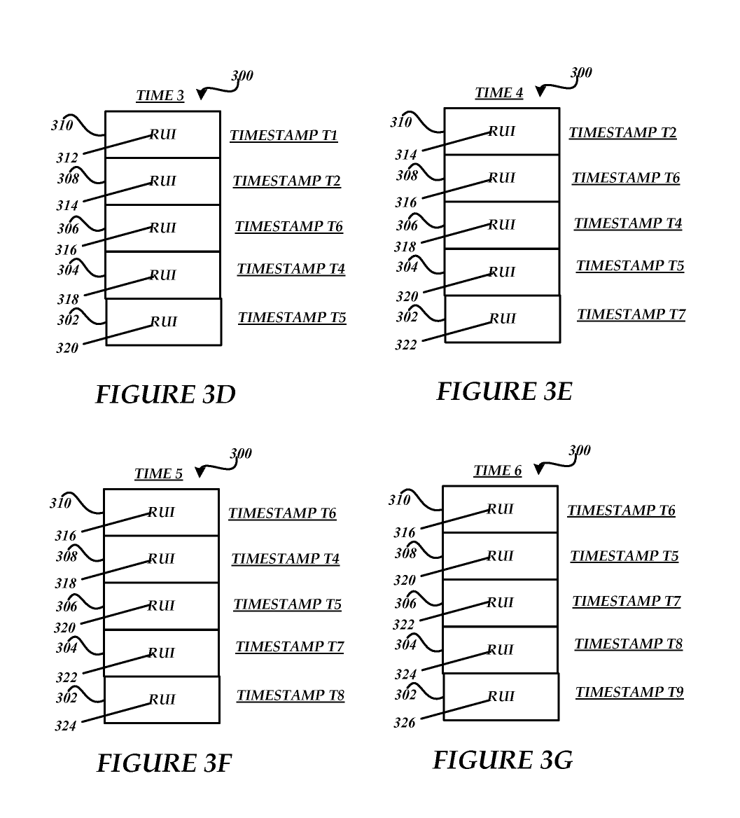

FIGS. 3A-3G depict list population examples for a recent items list 300 using a population algorithm as part of preserving relative ordering of list items and maintaining an end-user's recently used or viewed list. As shown in FIG. 3A, the exemplary recent items list 300 includes a finite number of displayable item locations 302-310 at Time 0 which are currently empty, either due to an initial use or resulting from a clear list operation. For these examples, list items are populated from the bottom of the list to the top.

As shown in FIG. 3B, at Time 1, a first recently used item (RUI) 312 has been added to list location 302. A timestamp T1 is shown next to listed RUI 312 to illustrate recording of the last viewed time of RUI 312 using the population algorithm. Timestamps are not included as part of the presentation of the recent items list 300 for this example. An exemplary list data structure can maintain timestamps that include month, day, year, and/or local and/or remote access times.

As shown in FIG. 3C, at some time later after multiple use operations (Time 2), the list 300 is now full and RUI 312 is now located at list location 310. Timestamps T1-T5 are shown next to each RUI 312-RUI 320 to illustrate recording of the corresponding last viewed times using the population algorithm. For this example, timestamp T5 is more recent than timestamps T4-T1, timestamp T4 is more recent than timestamps T3-T1, timestamp T3 is more recent than timestamps T2-T1, and timestamp T2 is more recent than timestamp T1. Timestamps of one embodiment can be configured to reflect an elapsed time from last use, wherein the population algorithm can reset an elapsing timestamp of a list item associated with a reused list item. Note how relative list item positions of reused list items are maintained or geographically anchored to provide a familiar list interface for an associated end-user.

As shown in FIG. 3D, at Time 3, the list reflects a reuse operation, wherein the geographic relative positioning of the list items has been maintained or anchored, while the timestamp has been updated (timestamp T6) to reflect the reuse or reselection operation by the user of existing list item 316. Timestamp T6 is more recent than timestamps T5, T4, T2, and T1. The reuse operation can result from selecting an item directly from the list or some application associated with a list item (e.g., file system, search system, selected note link, etc.).

As shown in FIG. 3E, at Time 4, a new RUI 322 has been added to the list 300 at list location 302. A corresponding timestamp T7 is shown next to the list location 302 to illustrate the recording of the last viewed time of RUI 322. RUI 312 has been removed from the list 300 based on the population algorithm's selective removal of least recently used list items when adding new items to the list.

As shown in FIG. 3F, at Time 5, a new RUI 324 has been added to the list 300 at list location 302. A corresponding timestamp T8 is shown next to the list location 302 to illustrate the recording of the last viewed time of RUI 324. RUI 314 has been removed from the list 300 based on the population algorithm's removal of least recently used list items when adding new items to the list.

As shown in FIG. 3G, at Time 6, a new RUI 326 has been added to the list 300 at list location 302. A corresponding timestamp T9 is shown next to the list location 302 to illustrate the recording of the last viewed time of RUI 326. RUI 318 has been removed from the list 300 based on the use of the population algorithm to remove least recently used list items when adding new items to the list.

FIG. 4 depicts a smartphone 400 that includes a recent note item list interface 402 having a finite number of list item locations 404-420. As shown in FIG. 4, list item location 404 includes a shopping list note item 422, list item location 406 includes an other notes list item 424, list item location 408 includes an idea for a renovation project note item 425, list item location 410 includes a flight reservation note item 428, list item location 412 includes a phone number associated with a to-do note item 430, list item location 414 includes a hyperlink note item 432, list item location 416 includes a book title note item 434, list item location 418 includes a photos note item 436, and list item location 420 includes a recipe note item 438. The list interface 402 can be populated and maintained using a population algorithm as described in detail above. As shown, each note item is displayed to include a descriptive title, a note path or page location, and/or a representative icon.

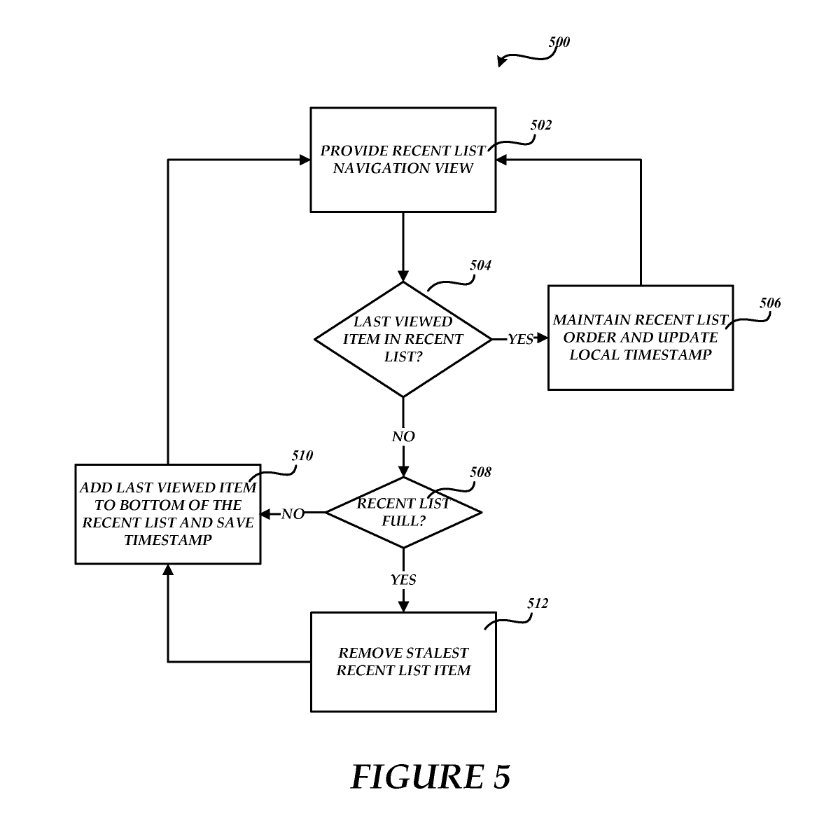

FIG. 5 is a flow diagram depicting an exemplary process 500 that includes the use of a recent list population algorithm to maintain aspects of a recent list of viewed or visited note items using a computer application, such as note-taking application installed on a smartphone for example. The process 500 can be used as part of an offline and/or online note-taking experience. For example, the exemplary process 500 can use the recent list population algorithm as part of presenting a list of recently used note-taking application items using an interactive note-taking application interface.

Once note-taking application features are installed and a user is signed in, the process 500 of one embodiment uses the recent list population algorithm to provide list maintenance operations as part of providing note-taking application interface features. For example, a user can use a smartphone to connect and install a note-taking application on the smartphone. The process 500 can be implemented as part of a shared-note taking experience wherein a user shares notes with others and accesses shared notes using different end-user devices (e.g., a desktop, laptop, smartphone, etc.).

The process 500 of an embodiment begins when a user selects, uses, accesses, views or otherwise interacts with an associated application item, such as a note-taking application item for example. In another embodiment, the process 500 can begins as part of opening a recent item list. The process 500 at 502 provides a recent list navigation view as part of an interface to display a recent list and includes a finite number of list locations to contain a finite number of viewed note items. In one embodiment, prior to or during operation 502, the process 500 can perform a synchronization operation or operations as part of maintaining timestamps of list items. Synchronization operations can also be performed at different times associated with the process 500 or some other process. For example, a user may have recently switched to using a note-taking application installed on a smartphone after having previously used a laptop or desktop version of the note-taking application to interact with and/or create one or more note items. According to such an embodiment, the process 500 can operate to update any local and/or remote item timestamps based on newer timestamps stored on either the server or locally for the same note items.

At 504, the process 500 of an embodiment determines if a currently used or last viewed note item is included in the recent list. For example, the process 500 can use a user selected application item input from within an application, a directory location, etc. as part of using the recent list population algorithm to maintain a presentation of list items. If the last viewed note item is already included in the recent list at 504, the process 500 then proceeds to 506 and maintains the list order of the recent list, including updating the timestamp for the last viewed note item.

If the last viewed note item is not included in the recent list at 504, at 508 the process 500 determines if the recent list is full of viewed note items. If the recent list is not determined to be full at 508, the process 500 proceeds to 510 and information associated with the last viewed note item is added to a bottom item location in the recent list and the associated timestamp is stored. If the recent list is determined to be full at 508, the process 500 proceeds to 512 and removes the stalest or oldest item from the recent list based on the associated timestamp, and then proceeds to 510 where the last viewed item is added to the bottom item location in the recent list and the associated timestamp is stored and the process 500 proceeds to 502.

Based on the location of a removed item in the recent items list, the process 500 can refresh the remaining existing items in the recent list to preserve a relative ordering of the remaining items. In one embodiment, the process 500 can be configured to repopulate the entire list or some portion thereof based on a repopulation algorithm (e.g., random, order preservation, geographic anchoring, etc.) using timestamps of list items. In an alternative embodiment, the process 500 can operate to replace a removed item with the last viewed item as part of maintaining relative geographic list positioning features.

The exemplary process 500 can provide note-taking application features as part of encoded computer software for use in recording, organizing, editing, and/or transmitting audio, visual, and other information in electronic form, including functionality providing for viewing and editing meeting agendas, to-do lists, reminding users of dates and/or events, creating and/or accessing shared note items, emailing notes, and publishing notes on computer networks using computer input/output components including touch-based, voice-activated, pen-based, etc. for inputting note item data into a computing device or system. While a certain number and order of operations is described for the exemplary flow of FIG. 5, it will be appreciated that other numbers and/or orders can be used according to desired implementations.

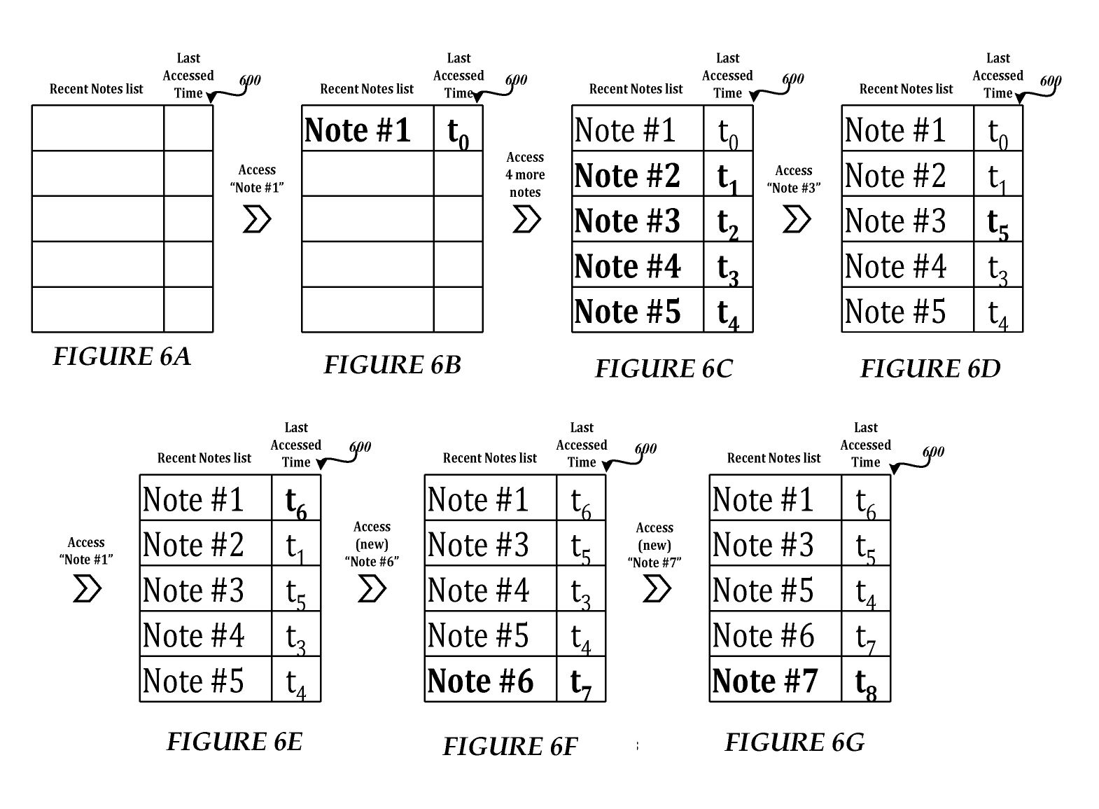

FIGS. 6A-6G depict list population examples corresponding to using a population algorithm and a data structure 600 to track recent notes and last accessed times of note items as part of preserving a relative ordering and/or list positions of list items. As shown by the examples, the data structure 600 tracks the population of visited note pages corresponding to presentation of a recent notes list. The data structure 600 can be used to maintain a recent notes list when an end-user navigates to a new page by any means, wherein information associated with a page that an end-user left or navigated away from will be considered for addition to the recent notes list.

Thus, in accordance with an embodiment, the data structure 600 tracks addition of visited pages when the user leaves the associated pages. In some cases, and in accordance with an embodiment, certain visited pages are not added to the recent notes list including: previewing page navigations in a navigation dropdown or search; pages visited for less than ten seconds or some other time period; and/or pages included in a password protected section. Pages included in a recent list can be tracked by the section and/or page GUID. Caching operations can include caching of Page Title, Thumbnail at the time of leaving the page, and/or a recency timestamp.

A maintenance algorithm that includes insertion logic is used with the data structure 600 to maintain visible items of the recent notes list that includes, but is not limited to: if a recently exited or visited page is in the first number of visible slots (e.g., six, etc.), update the corresponding recency timestamp to the current or last viewed time, and update an associated thumbnail to the latest view; if a page is not in the first number of visible slots already, insert (or move it) the information associated with the page at the beginning of the list, update the associated timestamp and/or thumbnail, wherein the maintenance algorithm operates to remove a least recently used or least frequently used page of the number of visible list items when the list is full and insert the most recently viewed page in the list, either in top or bottom of the list, or replacing a removed page list item.

The insertion logic keeps most recent pages in the list while also operating to maintain repeatedly visited pages at mostly fixed geographic positions as part of preserving relative ordering and/or positioning of list items. As an example, a data structure 600 can track a certain number of recent note items, wherein stalest or oldest items can be removed when the number of recent note items exceeds a certain number (e.g., 30, etc.). The data structure 600 enables the recent list to be remembered across sessions (e.g., stored in cache memory). In one embodiment, list item timestamps are only updated in the data structure 600 based on local last accessed time values. Timestamps can be stored locally and/or remotely.

As shown in FIG. 6A, the exemplary data structure 600 is empty which reflects an absence of any list item information. For example, a user may not have accessed a note as of yet.

As shown in FIG. 6B, Note #1 now appears in the data structure 600 along with the last accessed time due to a user leaving a recently accessed page. Correspondingly, information associated with Note #1 can be displayed at a top position of a corresponding visible notes list.

As shown in FIG. 6C, Notes #2-#5 now appear in the data structure 600 along with the last accessed times due to a user recently leaving the accessed pages. Correspondingly, information associated with each note can be populated in the corresponding visible notes list based in temporal order (t₄ is more recent than t₃, etc.). Timestamps of one embodiment can be configured to reflect an elapsed time from last visited, wherein the algorithm can reset an elapsing timestamp of a list item associated with a reused or revisited list item.

As shown in FIG. 6D, the data structure 600 is shown to reflect a revisit operation associated with Note #3, wherein the geographic positioning of the list items has been maintained (no change in list order) by the algorithm and the timestamp has also been updated (now t₅) to reflect the time of revisiting or a page existing time (t₅ is more recent than t₄, etc.).

As shown in FIG. 6E, the data structure 600 is shown to reflect another revisit operation associated with Note #1, wherein the geographic positioning of the list items has been maintained (no change in list order) by the algorithm and the timestamp has also been updated (now t₆) to reflect the time of revisiting or a page exit time (t₆ is more recent than t₅, etc.).

As shown in FIG. 6F, the data structure 600 now includes Note #6 along with an associated timestamp. Information associated with the new item (Note #6) can be inserted at the bottom of the corresponding visible notes list (reflected by the data structure 600). The algorithm has removed Note #2 due to having the oldest timestamp or least recently accessed time of the visible items. The algorithm moves Notes #3, #4, and #5 each up one position in the visible notes list as reflected by the data structure 600.

As shown in FIG. 6G, the data structure 600 now includes Note #7 along with an associated timestamp. Information associated with the most recently accessed item (Note #7) can be inserted at the bottom of the corresponding visible notes list (reflected by the data structure 600). The algorithm has removed Note #4 due to having the oldest timestamp or least recently accessed time of the visible items. The algorithm moves Notes #5 and #6 each up one position in the visible notes list as reflected by the data structure 600.

While a number of examples are shown for illustrative purposes it will be appreciated that other embodiments and examples are included and available.

It will be appreciated that the list population and interface features can be implemented as part of a processor-driven computer environment. Also, while certain embodiments are described herein, other embodiments are available, and the described embodiments should not be used to limit the claims. Suitable programming means include any means for directing a computer system or device to execute steps of a method, including for example, systems comprised of processing units and arithmetic-logic circuits coupled to computer memory, which systems have the capability of storing in computer memory, which computer memory includes electronic circuits configured to store data and program instructions. An exemplary computer program product is useable with any suitable data processing system. While a certain number and types of components are described above, it will be appreciated that other numbers and/or types and/or configurations can be included according to various embodiments. Accordingly, component functionality can be further divided and/or combined with other component functionalities according to desired implementations.

The term computer readable media as used herein can include computer storage media. Computer storage media can include volatile and nonvolatile, removable and non-removable media implemented in any method or technology for storage of information, such as computer readable instructions, data structures, program modules, etc. System memory, removable storage, and non-removable storage are all computer storage media examples (i.e., memory storage.). Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by a computing device. Any such computer storage media may be part of a device or system. By way of example, and not limitation, communication media may include wired media such as a wired network or direct-wired connection, and wireless media such as acoustic, RF, infrared, and other wireless media.

The embodiments and examples described herein are not intended to be limiting and other embodiments are available. Moreover, the components described above can be implemented as part of networked, distributed, and/or other computer-implemented environment. The components can communicate via a wired, wireless, and/or a combination of communication networks. Network components and/or couplings between components of can include any of a type, number, and/or combination of networks and the corresponding network components which include, but are not limited to, wide area networks (WANs), local area networks (LANs), metropolitan area networks (MANs), proprietary networks, backend networks, cellular networks, etc.

Client computing devices/systems and servers can be any type and/or combination of processor-based devices or systems. Additionally, server functionality can include many components and include other servers. Components of the computing environments described in the singular tense may include multiple instances of such components. While certain embodiments include software implementations, they are not so limited and encompass hardware, or mixed hardware/software solutions.

Terms used in the description, such as component, module, system, device, cloud, network, and other terminology, generally describe a computer-related operational environment that includes hardware, software, firmware and/or other items. A component can use processes using a processor, executable, and/or other code. Exemplary components include an application, a server running on the application, and/or an electronic communication client coupled to a server for receiving communication items. Computer resources can include processor and memory resources such as: digital signal processors, microprocessors, multi-core processors, etc. and memory components such as magnetic, optical, and/or other storage devices, smart memory, flash memory, etc. Communication components can be used to communicate computer-readable information as part of transmitting, receiving, and/or rendering electronic communication items using a communication network or networks, such as the Internet for example. Other embodiments and configurations are included.

### Exemplary Operating Environment

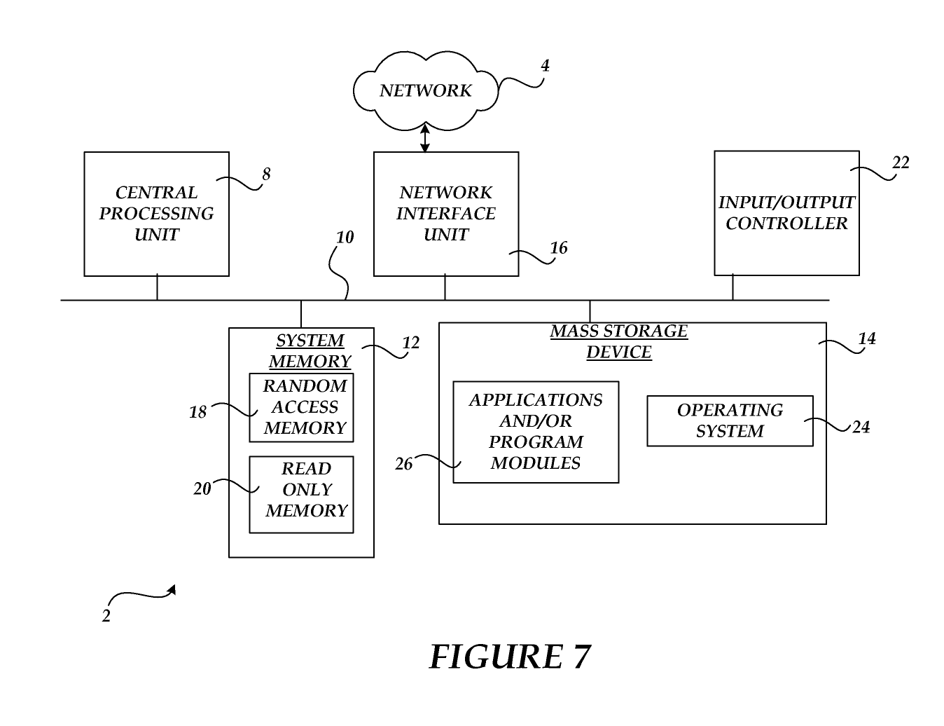

Referring now to FIG. 7, the following discussion is intended to provide a brief, general description of a suitable computing environment in which embodiments of the invention may be implemented. While the invention will be described in the general context of program modules that execute in conjunction with program modules that run on an operating system on a personal computer, those skilled in the art will recognize that the invention may also be implemented in combination with other types of computer systems and program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Referring now to FIG. 7, an illustrative operating environment for embodiments of the invention will be described. As shown in FIG. 7, computer 2 comprises a general purpose server, desktop, laptop, handheld, or other type of computer capable of executing one or more application programs. The computer 2 includes at least one central processing unit 8 (“CPU”), a system memory 12, including a random access memory 18 (“RAM”) and a read-only memory (“ROM”) 20, and a system bus 10 that couples the memory to the CPU 8. A basic input/output system containing the basic routines that help to transfer information between elements within the computer, such as during startup, is stored in the ROM 20. The computer 2 further includes a mass storage device 14 for storing an operating system 24, application programs, and other program modules/resources 26.

The mass storage device 14 is connected to the CPU 8 through a mass storage controller (not shown) connected to the bus 10. The mass storage device 14 and its associated computer-readable media provide non-volatile storage for the computer 2. Although the description of computer-readable media contained herein refers to a mass storage device, such as a hard disk or CD-ROM drive, it should be appreciated by those skilled in the art that computer-readable media can be any available media that can be accessed or utilized by the computer 2.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 2.

According to various embodiments of the invention, the computer 2 may operate in a networked environment using logical connections to remote computers through a network 4, such as a local network, the Internet, etc. for example. The computer 2 may connect to the network 4 through a network interface unit 16 connected to the bus 10. It should be appreciated that the network interface unit 16 may also be utilized to connect to other types of networks and remote computing systems. The computer 2 may also include an input/output controller 22 for receiving and processing input from a number of other devices, including a keyboard, mouse, etc. (not shown). Similarly, an input/output controller 22 may provide output to a display screen, a printer, or other type of output device.

As mentioned briefly above, a number of program modules and data files may be stored in the mass storage device 14 and RAM 18 of the computer 2, including an operating system 24 suitable for controlling the operation of a networked personal computer, such as the WINDOWS operating systems from MICROSOFT CORPORATION of Redmond, Wash. The mass storage device 14 and RAM 18 may also store one or more program modules. In particular, the mass storage device 14 and the RAM 18 may store application programs, such as word processing, spreadsheet, drawing, e-mail, and other applications and/or program modules, etc.

It should be appreciated that various embodiments of the present invention can be implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, logical operations including related algorithms can be referred to variously as operations, structural devices, acts or modules. It will be recognized by one skilled in the art that these operations, structural devices, acts and modules may be implemented in software, firmware, special purpose digital logic, and any combination thereof without deviating from the spirit and scope of the present invention as recited within the claims set forth herein.

Although the invention has been described in connection with various exemplary embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

What is claimed is:

1. A method comprising:
providing a data structure corresponding to a list having a finite number of displayable list item locations;
populating the displayable list item locations of the list with user selected items including using a population algorithm to populate the displayable list item locations with selected item information to be displayed in the list, including using the population algorithm in part to preserve reused item list positions for repeat accesses of existing list items;
updating the data structure associated with the list to include new information associated with a newly accessed item not currently existing in the list, wherein the population algorithm is configured to locate the newly accessed item in a predetermined displayable list location and replace information associated with a stalest existing item when the list is full; and
storing the data structure in computer storage.

2. The method of claim 1, further comprising updating the data structure based in part on a time reference associated with an existing item in the list.

3. The method of claim 2, further comprising updating the data structure based in part on an oldest timestamp associated with the stalest existing item in the list when the list is full.

4. The method of claim 3, further comprising removing the stalest existing item from the list when the list is full as part of inserting a recently viewed item at a bottom list location, wherein the oldest timestamp is based in part on a viewed time.

5. The method of claim 3, further comprising removing the stalest existing item from the list when the list is full as part of inserting a recently viewed item at a top list location, wherein the oldest timestamp is based in part on a viewed time.

6. The method of claim 1, further comprising updating the data structure associated with the list to include new information associated with a newly used item absent from the list, wherein the newly used item is displayed in a predetermined displayable list location and an associated temporal reference is stored in the computer storage.

7. The method of claim 6, further comprising populating the list using the population algorithm to insert a most recently viewed item at a bottom displayable list item location of the list.

8. The method of claim 6, further comprising populating the list using the population algorithm to insert a most recently viewed item at a top displayable list item location of the list.

9. The method of claim 1, further comprising using a server in part to maintain list item timestamps.

10. The method of claim 1, further comprising populating the list using the population algorithm to remove the stalest list item having the oldest last viewed time from the list and updating the displayable list item locations with remaining items in the list.

11. The method of claim 1, further comprising populating the list using the population algorithm to populate the displayable list item locations until the list is full and then first removing an oldest list item and replacing the removed item with one of another existing list item or a recently selected application item.

12. The method of claim 1, further comprising maintaining the list as part of tracking recently used items associated with a note-taking application on a handheld device, wherein local use timestamps are used with the population algorithm as part of maintaining the list.

13. A handheld device comprising:
processor and memory resources;
a recent list data structure that corresponds with a presentation of a finite number of list items of a recent list;
a population component that includes an algorithm configured in part to populate display items of the recent list based in part on maintenance of a list position of one or more frequently reused list items, insert most recently used items at a defined position in the recent list, and selectively remove list items for full capacity list population operations; and
a display interface to display the presentation of the finite number of list items included as part of the recent list.

14. The handheld device of claim 13, the algorithm further configured to use locally generated timestamps in part to maintain the recent list.

15. The handheld device of claim 13, the algorithm further configured to use remotely controlled timestamps in part to maintain the recent list.

16. The handheld device of claim 13, further comprising a note-taking application and a recent item navigation menu used to display a finite number of note-taking application items.

17. Computer storage, including instructions which, when executed, provide a list of information by:
generating a navigation pane for the list of information having a finite number of item locations based in part on user selections including populating the finite number of item locations with information associated with the user selections as part of maintaining geographic anchoring features of list items based on the user selections;
maintaining the list of information associated with the user selections to include new selection information associated with a most recently viewed item absent from the list at a fixed location in the list including determining when the list is full of user selection information and replacing selection information associated with a least recent or least frequent used list item when the list is full; and
providing an output for displaying the list of information using a display interface.

18. The computer storage of claim 17, including instructions which, when executed, provide the list of information using a recent items population algorithm configured in part to preserve geographic positioning of list items by maintaining a list ordering configuration as part of repeat accesses to existing list items.

19. The computer storage of claim 17, including instructions which, when executed, provide the list of information including maintaining list information by updating a reused item timestamp when an existing list item is reselected.

20. The computer storage of claim 17, including instructions which, when executed, provide the list of information including maintaining list information by replacing a removed note item from a user recent notes list with one of an existing note item having a more recent timestamp than the removed item or a recently selected note item absent from the recent notes list.
